(19) United States
(12) Patent Application Publication
(10) Pub. No.: US 2017/0315241 A1
(43) Pub. Date: Nov. 2, 2017

(54) RADIATION MONITOR AND RADIATION MONITORING METHOD

(71) Applicant: HITACHI, LTD., Tokyo (JP)

(72) Inventors: Takahiro TADOKORO, Tokyo (JP); Kazuo TOMINAGA, Tokyo (JP); Katsunori UENO, Tokyo (JP); Kouichi OKADA, Tokyo (JP); Yasushi NAGUMO, Tokyo (JP); Hitoshi KUWABARA, Tokyo (JP); Keisuke SASAKI, Tokyo (JP)

(73) Assignee: HITACHI, LTD., Tokyo (JP)

(21) Appl. No.: 15/531,910

(22) PCT Filed: Nov. 27, 2015
(86) PCT No.: PCT/JP2015/083306

§ 371 Date: May 31, 2017

(30) Foreign Application Priority Data
Dec. 11, 2014 (JP) 2014-251334

(51) Int. Cl. G01T 1/20; G01T 7/00

(52) U.S. Cl. CPC G01T 1/20; G01T 7/00

(57) ABSTRACT

A radiation monitor for accurately measuring the dose rate of radiation by suppressing the risk of explosion or the like is provided. The radiation monitor includes a radiation emitting element which includes a light emitting part emitting light of an intensity corresponding to a dose rate of incident radiation, an optical fiber which is connected to the radiation emitting element and transmits the light emitted from the light emitting part, an electric pulse converter which is connected to the optical fiber and transmits one electric pulse for one photon of the transmitted light, an electric pulse detector which is connected to the electric pulse converter and counts the electric pulse transmitted from the electric pulse converter, and an analyzer which is connected to the electric pulse detector and converts the electric pulse count rate obtained by the electric pulse detector into a radiation dose rate.

### TECHNICAL FIELD

The present invention relates to a radiation monitor and a radiation monitoring method.

### BACKGROUND ART

As a monitor for measuring the dose rate of radiation, a radiation monitor using an ionization chamber and a radiation monitor using a scintillation element are known.

The above-described radiation monitor using the ionization chamber uses the ionization of a gas in the ionization chamber caused by the incident radiation, and can simply measure the dose rate of the radiation by measuring a current generated by the application of a voltage to the ionization chamber.

Meanwhile, the radiation monitor using the scintillation element uses the light emission from the element caused by the incident radiation. Specifically, the radiation monitor measures the intensity of the emitted light as a current using a photomultiplier tube or the like and calculates the dose rate from the current value (for example, see PTL 1).

### CITATION LIST

### Patent Literature

PTL 1: Japanese Patent Application Laid-Open No. 2009-36752

### SUMMARY OF INVENTION

### Technical Problem

However, in the above-described radiation monitor using the ionization chamber, it is essential to enlarge the ionization chamber when measuring radiation at a low dose rate due to a small interaction between radiation and gas. In addition, there is a risk of explosion or the like under the presence of hydrogen or the like due to the application of a high voltage. Therefore, it is difficult to apply the radiation monitor.

Further, in the above-described radiation monitor using the conventional scintillation element, since electrical signals overlap each other when a high dose rate is measured, it is difficult to correctly measure the dose rate. In order to avoid this problem, it is conceivable to cover the periphery of the above-described element with a radiation shield such as a lead. However, since the radiation monitor becomes very large and heavy, it is difficult to mention that the simplicity of measurement is always sufficient.

The invention has been made in view of the above-described circumstances and an object of the invention is to provide a radiation monitor and a radiation monitoring method capable of simply and accurately measuring the dose rate of radiation by suppressing the risk of explosion or the like.

### Solution to Problem

The invention to solve the above issue is a radiation monitor including: a radiation emitting element which includes a light emitting part emitting light of an intensity corresponding to a dose rate of incident radiation; an optical fiber which is connected to the radiation emitting element and transmits the light emitted from the light emitting part; an electric pulse converter which is connected to the optical fiber and transmits one electric pulse for one photon of the transmitted light; an electric pulse detector which is connected to the electric pulse converter and counts the electric pulse transmitted from the electric pulse converter; and an analyzer which is connected to the electric pulse detector and converts the electric pulse count rate obtained by the electric pulse detector into a radiation dose rate.

Alternatively, a radiation monitoring method includes: emitting light of an intensity corresponding to a dose rate of incident radiation from a light emitting part of a radiation emitting element; transmitting the light emitted from the light emitting part by an optical fiber; transmitting one electric pulse for one photon of the transmitted light by an electric pulse converter; counting the electric pulse transmitted from the electric pulse converter by an electric pulse detector; and converting the electric pulse count rate counted by the electric pulse detector into a radiation dose rate by an analyzer.

The radiation monitor preferably further includes a wavelength filter which is provided in the middle of the optical fiber and allows a transmission of only light within a predetermined wavelength range.

The radiation monitor preferably further includes a light attenuation filter which is provided in the middle of the optical fiber and attenuates the light emitted from the radiation emitting element at a predetermined ratio so as to fall within a predetermined intensity range.

In the radiation monitor, the radiation emitting element preferably includes a light emitting part, a housing which receives the light emitting part, and an intermediate member that is provided between the housing and the light emitting part and has a thermal emissivity smaller than a thermal emissivity of an inner surface of the housing.

In the radiation monitor, the light emitting part preferably contains at least one rare earth element.

In the radiation monitor, the radiation emitting element is preferably received in a virtual area in which an outer shape of the optical fiber at a connection portion between the radiation emitting element and the optical fiber is extended in an axial direction of the optical fiber.

Another invention to solve the above issue is a radiation monitor including: a first radiation emitting element which includes a first light emitting part containing at least one rare earth element and emitting light of an intensity corresponding to a dose rate of incident radiation; a first optical fiber which is connected to the first radiation emitting element and transmits the light emitted from the first light emitting part; a first electric pulse converter which is connected to the first optical fiber and transmits one electric pulse for one photon of the transmitted light; a first electric pulse detector which is connected to the first electric pulse converter and counts the electric pulse transmitted from the first electric pulse converter; a second radiation emitting element which includes a second light emitting part not containing a rare earth element; a second optical fiber which is connected to the second radiation emitting element and transmits light emitted from the second light emitting part; a second electric pulse converter which is connected to the second optical fiber and transmits one electric pulse for one photon of the transmitted light; a second electric pulse detector which is connected to the second electric pulse converter and counts the electric pulse transmitted from the second electric pulse converter; and a differential analyzer which is connected to the first and second electric pulse detectors, calculates a difference in electric pulse count rate from the electric pulses counted by the first and second electric pulse detectors, and converts the difference into a radiation dose rate, wherein the first radiation emitting element 10a and the second radiation emitting element 10b are provided to be adjacent to each other.

The radiation monitor preferably further includes: a first wavelength filter which is provided in the middle of the first optical fiber and allows a transmission of only light within a predetermined wavelength range; and a second wavelength filter which is provided in the middle of the second optical fiber and allows a transmission of only light within the predetermined wavelength range.

The radiation monitor preferably further includes: a first light attenuation filter which is provided in the middle of the first optical fiber and attenuates the light emitted from the first radiation emitting element at a predetermined ratio as to fall within a predetermined intensity range; and a second light attenuation filter which is provided in the middle of the second optical fiber and attenuates the light emitted from the second radiation emitting element at the predetermined ratio so as to fall within the predetermined intensity range.

In the radiation monitor, the first radiation emitting element preferably includes a first light emitting part, a first housing which receives the first light emitting part, and a first intermediate member that is provided between the first housing and the first light emitting part and has a thermal emissivity smaller than a thermal emissivity of an inner surface of the first housing, and the second radiation emitting element preferably includes a second light emitting part, a second housing which receives the second light emitting part, and a second intermediate member that is provided between the second housing and the second light emitting part and has a thermal emissivity smaller than a thermal emissivity of an inner surface of the second housing.

In the radiation monitor, the first radiation emitting element is preferably received in a virtual area in which an outer shape of the first optical fiber at a connection portion between the first radiation emitting element and the first optical fiber is extended in an axial direction of the first optical fiber, and the second radiation emitting element is preferably received in a virtual area in which an outer shape of the second optical fiber at a connection portion between the second radiation emitting element and the second optical fiber is extended in an axial direction of the second optical fiber.

Additionally, the “electric pulse count rate” in the specification means the number of the electric pulses detected per unit time. Further, a “predetermined wavelength range” in the specification means a predetermined light wavelength range used to measure the radiation dose rate and specifically means a specific wavelength range in which light can be transmitted through the wavelength filter used in the radiation monitor. Further, a “predetermined intensity range” in the specification means a light intensity range in which one photon can be converted into one electric pulse which can be resolved in time by using the electric pulse converter used in the radiation monitor. Further, a “predetermined ratio” in the specification means a predetermined ratio (a conversion ratio) for attenuating (converting) the intensity of light and specifically means a ratio of the intensity of light having passed through the light attenuation filter with respect to light not having passed through the intensity of light attenuation filter.

### ADVANTAGEOUS EFFECTS OF INVENTION

The invention can provide a radiation monitor capable of simply and accurately measuring the dose rate of radiation by suppressing the risk of explosion or the like.

### BRIEF DESCRIPTION OF DRAWINGS

FIG. 1 is a schematic block diagram illustrating a first embodiment of a radiation monitor of the invention.

FIG. 2 is a schematic enlarged cross-sectional view of a radiation emitting element of the radiation monitor of FIG. 1.

FIG. 3 is a partially enlarged schematic diagram illustrating a preferred embodiment of the radiation emitting element of the radiation monitor of FIG. 1.

FIG. 4 is a schematic diagram illustrating an example of a relation between a radiation dose rate and the number of generated photons per unit time.

FIG. 5 is a schematic diagram illustrating a process of generating photons (light) by incident radiation.

FIG. 6 is a schematic diagram illustrating one use example of the radiation monitor of FIG. 1.

FIG. 7 is a schematic diagram illustrating another use example of the radiation monitor of FIG. 1.

FIG. 8 is a schematic block diagram illustrating a second embodiment of a radiation monitor of the invention.

FIG. 9 is a schematic diagram illustrating an example of a generation rate of each photon (light) generated by the radiation emitting element at the time of incidence of γ rays of a certain wavelength.

FIG. 10 is a schematic block diagram illustrating a third embodiment of a radiation monitor of the invention.

FIG. 11 is a schematic block diagram illustrating a fourth embodiment of a radiation monitor of the invention.

FIG. 12 is a schematic diagram illustrating a correction of a dose rate in the radiation monitor of FIG. 11.

### DESCRIPTION OF EMBODIMENTS

A radiation monitor of the invention includes: a radiation emitting element which includes a light emitting part emitting light of an intensity corresponding to a dose rate of incident radiation; an optical fiber which is connected to the radiation emitting element and transmits the light emitted from the light emitting part; an electric pulse converter which is connected to the optical fiber and transmits one electric pulse for one photon of the transmitted light; an electric pulse detector which is connected to the electric pulse converter and counts the electric pulse transmitted from the electric pulse converter; and an analyzer which is connected to the electric pulse detector and converts the electric pulse count rate obtained by the electric pulse detector into a radiation dose rate.

Further, a radiation monitor of the invention includes: a first radiation emitting element which includes a first light emitting part containing at least one rare earth element and emitting light of an intensity corresponding to a dose rate of incident radiation; a first optical fiber which is connected to the first radiation emitting element and transmits the light emitted from the first light emitting part; a first electric pulse converter which is connected to the first optical fiber and transmits one electric pulse for one photon of the transmitted light; a first electric pulse detector which is connected to the first electric pulse converter and counts the electric pulse transmitted from the first electric pulse converter; a second radiation emitting element which includes a second light emitting part not containing a rare earth element; a second optical fiber which is connected to the second radiation emitting element and transmits light emitted from the second light emitting part; a second electric pulse converter which is connected to the second optical fiber and transmits one electric pulse for one photon of the transmitted light; a second electric pulse detector which is connected to the second electric pulse converter and counts the electric pulse transmitted from the second electric pulse converter; and a differential analyzer which is connected to the first and second electric pulse detectors, calculates a difference in electric pulse count rate from the electric pulses counted by the first and second electric pulse detectors, and converts the difference into a radiation dose rate, wherein the first radiation emitting element and the second radiation emitting element are provided to be adjacent to each other.

Hereinafter, a radiation monitor of an embodiment of the invention will be described with reference to the drawings, but the invention is not limited to the description of the embodiment.

### First Embodiment

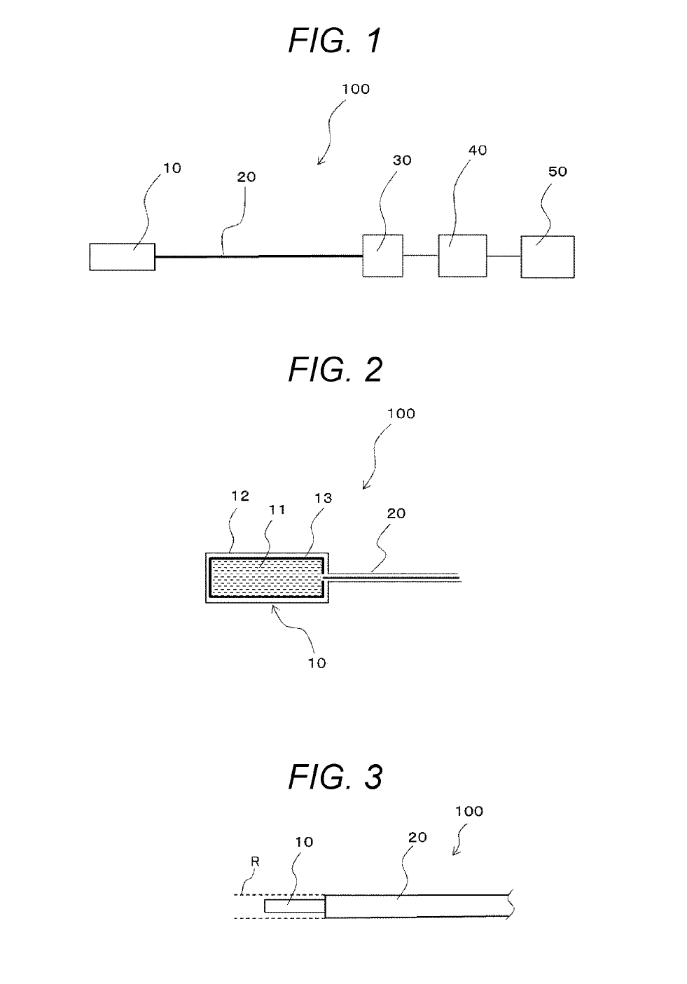

FIG. 1 is a schematic block diagram illustrating a first embodiment of the radiation monitor of the invention. As illustrated in FIG. 1, a radiation monitor 100 schematically includes a radiation emitting element 10, an optical fiber 20, an electric pulse converter 30, an electric pulse detector 40, and an analyzer 50. Additionally, examples of radiation that can be measured by the radiation monitor 100 include electromagnetic waves such as X-rays and γ-rays, particle beams such as α-rays, β-rays, and neutron rays, and the like.

The radiation emitting element 10 is an element that includes a light emitting part 11 emitting light having an intensity corresponding to the dose rate of incident radiation. The radiation emitting element 10 includes, as illustrated in FIG. 2, a light emitting part 11, a housing 12, and an intermediate member 13.

The light emitting part 11 contains at least one rare earth element. Specifically, the light emitting part 11 is formed of, for example, a light transmitting material such as transparent yttrium aluminum garnet as a base material and rare earth elements such as ytterbium, neodymium, cerium, and praseodymium contained in the light transmitting material.

In this way, since the light emitting part 11 contains at least one rare earth element, the linearity of the dose rate of the incident radiation in the light emitting part 11 and the intensity of the light can be improved. Thus, the radiation monitor 100 can more accurately measure the dose rate of radiation even when radiation of a high dose rate is incident.

The housing 12 is a container that receives the light emitting part 11. The material forming the housing 12 is not particularly limited as long as the material can transmit the radiation to be measured, and for example, aluminum or the like can be adopted.

The intermediate member 13 is a member that is provided between the housing 12 and the light emitting part 11 and has a thermal emissivity smaller than the thermal emissivity of the inner surface of the housing 12. In the embodiment, the intermediate member 13 is laminated as a mirror-like thin film on the inner surface of the housing 12. As the material forming the intermediate member 13, for example, gold, silver, and the like can be exemplified.

In this way, since the radiation emitting element 10 includes the intermediate member 13, the light emission derived from the heat radiation generated in the housing 12 can be reduced even when the radiation emitting element 10 is placed in a high temperature environment and thus the dose rate of radiation can be measured more accurately.

As illustrated in FIG. 3, it is preferable that the radiation emitting element 10 be received in a virtual region R in which an outer shape of the optical fiber 20 at a connection portion between the radiation emitting element 10 and the optical fiber 20 is extended in the axial direction of the optical fiber 20. Therefore, since it is possible to prevent a case in which a radiation measurement place is restricted by the size of the radiation emitting element 10, for example, the radiation monitor can be used to measure the details and to measure a high dose rate and a high spatial resolution in combination with a medical radiotherapy apparatus.

The optical fiber 20 is a medium which is connected to the radiation emitting element 10 and transmits light emitted from the light emitting part 11. The optical fiber 20 is connected to the radiation emitting element 10 and the electric pulse converter 30 to be described later. As the material forming the optical fiber 20, for example, quartz, plastics, and the like can be exemplified, but quartz is preferable from the viewpoint of prevention of deterioration under a high dose rate and long distance transmission.

The electric pulse converter 30 is a converter which connected to the optical fiber 20 and emits one electric pulse for each photon of the transmitted light. As the electric pulse converter 30, for example, a photomultiplier tube, an avalanche photodiode, or the like can be adopted. By using the photomultiplier tube or the like, it is possible to convert light (photon) into electric pulses having amplified current.

The electric pulse detector 40 is a detector which is connected to the electric pulse converter 30 and counts the electric pulse output from the electric pulse converter 30. As the electric pulse detector 40, for example, an oscilloscope or the like can be adopted.

The analyzer 50 is a device which is connected to the electric pulse detector 40 and converts the electric pulse count rate obtained by the electric pulse detector 40 into the radiation dose rate. Specifically, the analyzer 50 includes a storage device which stores a database indicating a correspondence between the electric pulse count rate and the radiation dose rate, a calculation device which converts the electric pulse count rate used in the database into the radiation dose rate, and a display device which displays the radiation dose rate (not illustrated). The analyzer 50 is not particularly limited as long as the electric pulse count rate can be converted into the radiation dose rate, and for example, a personal computer having the above-described function can be adopted.

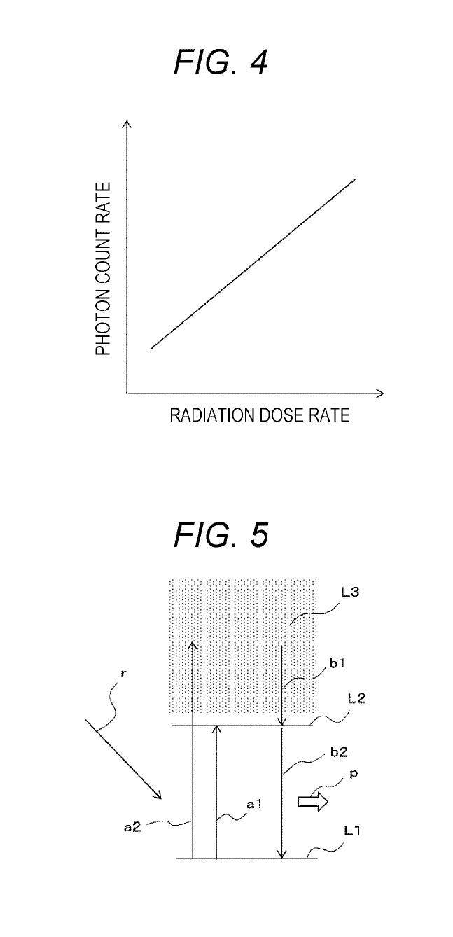

As illustrated in FIG. 4, the inventors found that there is a one-to-one correspondence between the dose rate of incident radiation and the number of photons per unit time (hereinafter also referred to as a “photon count rate”) emitted from the radiation emitting element 10 by experiment. On the other hand, it is known that there is a one-to-one correspondence between the photon count rate and the electric pulse count rate. Therefore, since there is also a one-to-one correspondence between the radiation dose rate and the electric pulse count rate, the obtained electric pulse count rate can be converted into the radiation dose rate by using this correspondence.

Here, since the correspondence between the radiation dose rate and the electric pulse count rate is different depending on the size and the shape of the radiation emitting element 10 to be used or the thickness or length of the optical fiber 20, the obtained electric pulse count rate can be converted into the radiation dose rate when the correspondence is obtained in advance for each radiation monitor in the form of a database. Additionally, a result derived from the analyzer 50 is not limited to the radiation dose rate and may be, for example, a change in dose rate with time or the like.

Next, the operation of the radiation monitor 100 will be described. FIG. 5 is a schematic diagram illustrating a process of generating photons (light) by incident radiation. As illustrated in FIG. 5, when the radiation r is incident to the radiation emitting element 10, the rare earth atoms and the like in the light emitting part 11 in the radiation emitting element 10 enter an excited state (for example, energy levels L2 and L3) of which energy is high due to the energy possessed by the radiation r (see the arrows a1 and a2 of FIG. 5).

Meanwhile, when the rare earth atoms and the like which are in the excited state (for example, the energy levels L2 and L3) of which energy is high enter an excited state of which energy is low or a ground state (for example, energy levels L1 and L2) (see the arrows b1 and b2 in FIG. 5), photon p (light) having energy corresponding to an energy difference is generated.

The photon p (light) which is generated in this way is transmitted to the electric pulse converter 30 through the optical fiber 20 to be converted into the electric pulse in the electric pulse converter 30. Next, the number of the electric pulses converted by the electric pulse converter 30 is counted by the electric pulse detector 40 and the obtained electric pulse count rate is converted into the radiation dose rate in combination with the database using the analyzer 50, thereby obtaining the dose rate of the incident radiation.

In this way, since the radiation monitor 100 includes the radiation emitting element 10, the optical fiber 20, the electric pulse converter 30, the electric pulse detector 40, and the analyzer 50, the incident radiation can be measured as the electric pulse count rate (the photon count rate) and thus the radiation dose rate can be simply and accurately measured. Further, since the radiation monitor 100 has the above-described configuration, it is possible to suppress the risk of explosion or the like to a degree in which a high voltage is not applied.

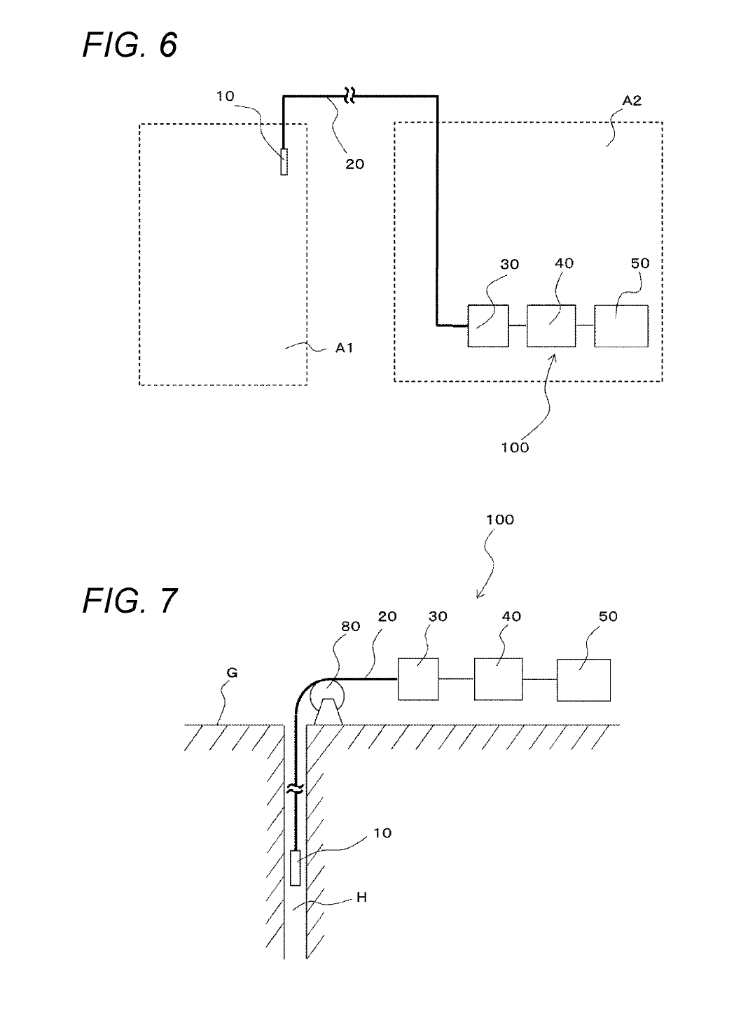

Next, a preferred use example of the radiation monitor 100 will be described. FIG. 6 is a schematic diagram illustrating one use example of the radiation monitor of FIG. 1. In this use example, the radiation emitting element 10 is provided inside a measurement area A1, the electric pulse converter 30, the electric pulse detector 40, and the analyzer 50 are provided outside a measurement area A2, and the radiation emitting element 10 and the electric pulse converter 30 are connected to each other by the optical fiber 20. For example, a harsh environment such as a high dose rate, a high temperature, a hydrogen/oxygen atmosphere, and the like is assumed inside the measurement area Al like a nuclear reactor building. Here, since the radiation emitting element 10 and the optical fiber 20 which do not need the application of a voltage and have excellent heat resistance and radiation resistance are provided inside the measurement area A1, the risk of explosion or the like can be further suppressed.

Further, FIG. 7 is a schematic diagram illustrating another use example of the radiation monitor of FIG. 1. In this use example, a radiation dose rate is measured at some positions in the depth direction of a hole H opened to a ground G. When such a measurement is performed, the radiation emitting element 10 needs to be moved in the depth direction. Here, when an optical fiber winding machine 80 capable of adjusting a supply length of the optical fiber 20 is provided and the radiation emitting element 10 is moved in the depth direction of the hole H, the radiation dose rate on the ground can be measured. Additionally, the radiation emitting element 10 may be mounted on a movement device (not illustrated) to measure a dose rate of an arbitrary area.

### Second Embodiment

FIG. 8 is a schematic block diagram illustrating a second embodiment of the radiation monitor of the invention. As illustrated in FIG. 8, a radiation monitor 200 schematically includes a radiation emitting element 10, an optical fiber 20, a wavelength filter 25, an electric pulse converter 30, an electric pulse detector 40, and an analyzer 50. The second embodiment is different from the first embodiment in that the wavelength filter 25 is further provided. Further, since the radiation emitting element 10, the optical fiber 20, the electric pulse converter 30, the electric pulse detector 40, and the analyzer 50 are the same as those of the first embodiment, the same reference numerals will be given to the same components and a detailed description thereof will be omitted.

The wavelength filter 25 is a filter which is provided in the middle of the optical fiber 20 and allows the transmission of only light within a predetermined wavelength range. The wavelength filter 25 is not particularly limited as long as the wavelength filter can transmit only light within a predetermined wavelength range. For example, an interference filter which is formed by coating a dielectric film on a planar substrate and uses an interference phenomenon of reflected light generated at the interface of the thin film can be adopted.

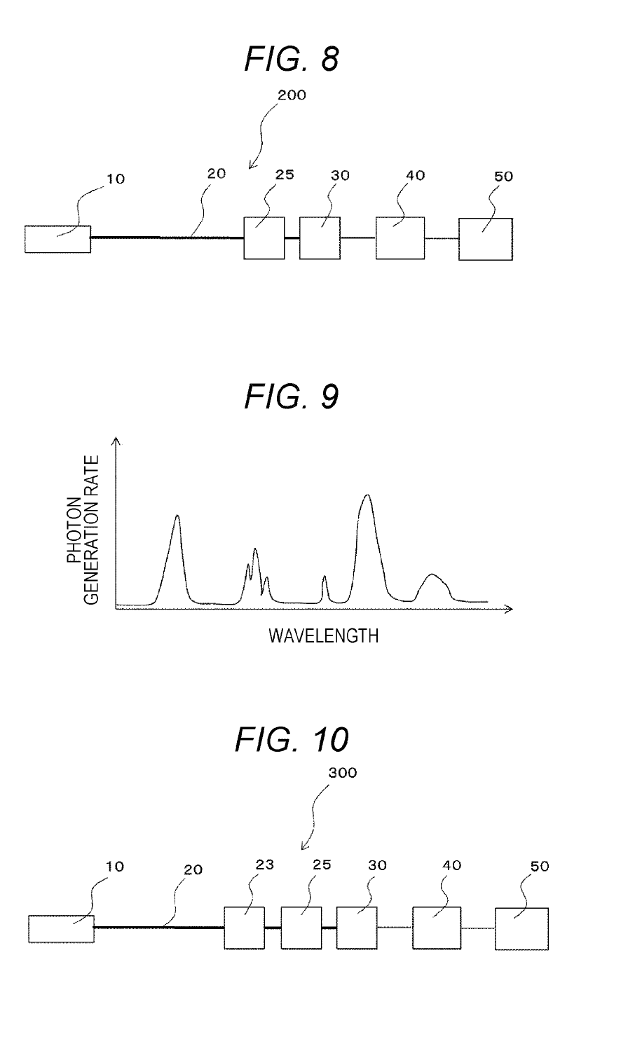

Next, the reason why the wavelength range that can be transmitted by the wavelength filter 25 is limited to the predetermined wavelength range will be described. When a rare earth atom or the like excited to a high energy level by incident radiation changes to a lower energy level, light (photon) having a wavelength corresponding to a difference in energy between transition energy levels is generated (see FIG. 5). FIG. 9 illustrates an example of the generation rate of each photon (light) generated by the radiation emitting element at the time of incidence of γ rays of a certain wavelength for each wavelength. As can be seen from this drawing, light of various wavelengths (photons) is generated by the incidence of the γ ray.

However, since the optical fiber 20 is deteriorated under a high dose rate environment, light of a relatively short wavelength becomes difficult to transmit due to scattering and absorption. Therefore, when only light transmitted through the wavelength filter 25 is transmitted to the electric pulse converter 30 by using the wavelength filter 25 that transmits only light of a relatively long wavelength which hardly causes scattering or the like, it is possible to measure only light of a relatively long wavelength which is not affected by the deterioration of the optical fiber and to measure the dose rate of radiation with high accuracy.

Meanwhile, since a relatively long wavelength of light is generated by heat radiation even within the radiation emitting element 10 and the optical fiber 20 under a high temperature environment, it is difficult to distinguish the light generated by the incident radiation. Therefore, when only the light transmitted through the wavelength filter 25 is transmitted to the electric pulse converter 30 by using the wavelength filter 25 that transmits only the light having a relatively short wavelength and not generated by the heat radiation in a high temperature environment, it is possible to measure only the light of a relatively short wavelength that is not affected by the radiation and to accurately measure the dose rate of the radiation.

The above-described predetermined wavelength range is equal to or larger than 700 nm and equal to or smaller than 1,300 nm in the case of the measurement under a high dose rate environment and a high temperature environment. The lower limit of the above-described predetermined wavelength range is preferably 800 nm and more preferably 900 nm from the viewpoint of improving the scattering prevention of the light transmitted through the optical fiber 20. Further, the upper limit of the above-described wavelength range is preferably 1,200 nm and more preferably 1,100 nm from the viewpoint of improving the suppression of light caused by heat radiation. In addition, when measuring a low dose rate environment in a high temperature environment of 300° C. or more, the wavelength is preferably 1,200 nm or less and the shorter wavelength is more preferable. When measuring a high dose rate in a room temperature environment, the wavelength is preferably equal to or larger than 800 nm and equal to or smaller than 2,500 nm from the viewpoint of improving the scattering prevention of the light transmitted through the optical fiber 20.

Additionally, since the operation of the radiation monitor 200 is the same as that of the radiation monitor 100 except that only light within a predetermined wavelength is transmitted using the wavelength filter 25, a description thereof will be omitted.

In this way, since the radiation monitor 200 includes the wavelength filter 25, the radiation dose rate can be measured by using only light of a predetermined wavelength range and thus the radiation dose rate can be more accurately measured even when the optical fiber is deteriorated or the environmental temperature is high.

### Third Embodiment

FIG. 10 is a schematic block diagram illustrating a third embodiment of the radiation monitor of the invention. As illustrated in FIG. 10, a radiation monitor 300 schematically includes a radiation emitting element 10, an optical fiber 20, a light attenuation filter 23, a wavelength filter 25, an electric pulse converter 30, an electric pulse detector 40, and an analyzer 50. The third embodiment is different from the second embodiment in that the light attenuation filter 23 is further provided. Additionally, since the radiation emitting element 10, the optical fiber 20, the wavelength filter 25, the electric pulse converter 30, the electric pulse detector 40, and the analyzer 50 are the same as those of the second embodiment, the same reference numerals will be given to the same components and a detailed description thereof will be omitted.

The light attenuation filter 23 is a filter which is provided in the middle of the optical fiber 20 and attenuates (converts) light emitted from the radiation emitting element 10 at a predetermined ratio so as to fall within a predetermined intensity range. The light attenuation filter 23 is not particularly limited as long as light can be attenuated (converted) within a predetermined intensity range at a predetermined ratio. For example, a neutral density (ND) filter or the like can be adopted. The light attenuation filter 23 is preferably used when the dose rate exceeds the upper limit of the photon count rate converted in the electric pulse converter 30.

Additionally, since the operation of the radiation monitor 300 is the same as that of the radiation monitor 100 except that the intensity of light transmitted by the optical fiber 20 is attenuated at a predetermined ratio so as to fall within a predetermined intensity range using the light attenuation filter 23, a description thereof will be omitted.

In this way, since the radiation monitor 300 includes the light attenuation filter 23, the radiation dose rate can be more accurately measured even when radiation having a high dose rate exceeding a time resolution of the electric pulse converter 30 is incident.

### Fourth Embodiment

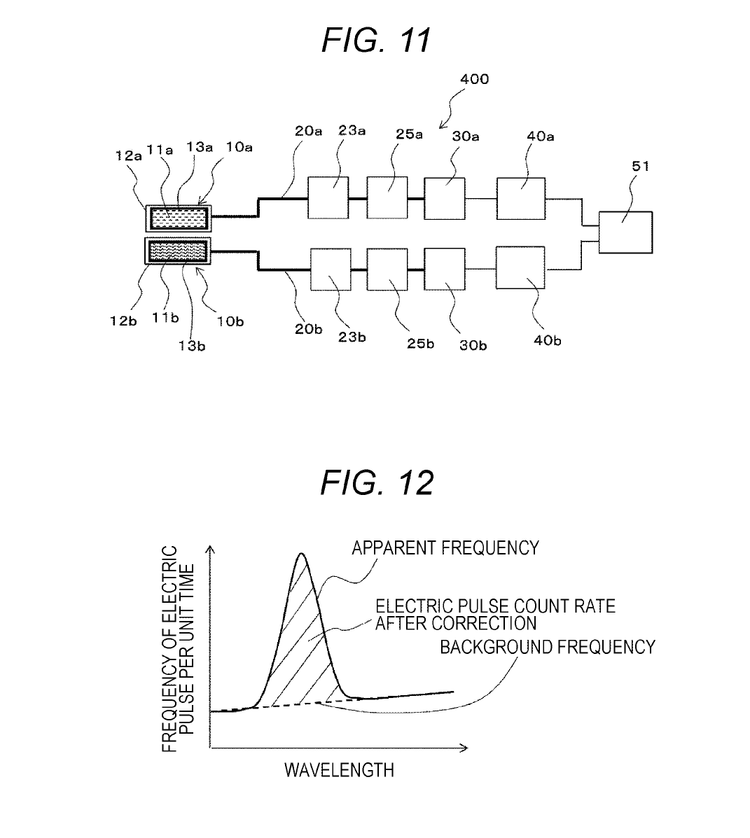

FIG. 11 is a schematic block diagram illustrating a fourth embodiment of the radiation monitor of the invention. As illustrated in FIG. 11, a radiation monitor 400 schematically includes a first radiation emitting element 10a, a first optical fiber 20a, a first light attenuation filter 23a, a first wavelength filter 25a, a first electric pulse converter 30a, a first electric pulse detector 40a, a second radiation emitting element 10b, a second optical fiber 20b, a second light attenuation filter 23b, a second wavelength filter 25b, a second electric pulse converter 30b, a second electric pulse detector 40b, and a differential analyzer 51.

The first optical fiber 20a is a medium which is connected to the first radiation emitting element 10a and transmits light emitted from the first light emitting part 11a. Further, the second optical fiber 20b is a medium which is connected to the second radiation emitting element 10b and transmits light emitted from the second light emitting part 11b.

The first light attenuation filter 23a is a filter which is provided in the middle of the first optical fiber 20a and attenuates light emitted from the first radiation emitting element 10a at a predetermined ratio so as to fall within a predetermined intensity range. Further, the second light attenuation filter 23b is a filter which is provided in the middle of the second optical fiber 20b and attenuates the light emitted from the second radiation emitting element 10b at a predetermined ratio so as to fall within a predetermined intensity range.

The first wavelength filter 25a is a filter which is provided in the middle of the first optical fiber 20a and allows the transmission only light within a predetermined wavelength range. Further, the second wavelength filter 25b is a filter which is provided in the middle of the second optical fiber 20b and allows the transmission of only light within a predetermined wavelength range.

The first electric pulse converter 30a is a converter which is connected to the first optical fiber 20a and transmits one electric pulse for one photon of the transmitted light. Further, the second electric pulse converter 30b is a converter which is connected to the second optical fiber 20b and transmits one electric pulse for one photon of the transmitted light.

The first electric pulse detector 40a is a detector which is connected to the first electric pulse converter 30a and counts the electric pulse transmitted from the first electric pulse converter 30a. Further, the second electric pulse detector 40b is a converter which is connected to the second electric pulse converter 30b and counts the electric pulse transmitted from the second electric pulse converter 30b.

Additionally, since the first and second optical fibers 20a and 20b are the same as the optical fiber 20, the first and second light attenuation filters 23a and 23b are the same as the light attenuation filter 23, the first and second wavelength filters 25a and 25b are the same as the wavelength filter 25, the first and second electric pulse converters 30a and 30b are the same as the electric pulse converter 30, and the first and second electric pulse detectors 40a and 40b are the same as the electric pulse detector 40, a detailed description thereof will be omitted.

The first radiation emitting element 10a includes a first light emitting part 11a, a first housing 12a which receives the first light emitting part 11a, and a first intermediate member 13a that is provided between the first housing 12a and the first light emitting part 11a and has a thermal emissivity smaller than a thermal emissivity of an inner surface of the first housing 12a and the second radiation emitting element 10b includes a second light emitting part 11b, a second housing 12b which receives the second light emitting part 11b, and a second intermediate member 13b which is provided between the second housing 12b and the second light emitting part 12b and has a thermal emissivity smaller than a thermal emissivity of an inner surface of the second housing 12b. Accordingly, since the light emission derived from the heat radiation generated in the first and second housings 12a and 12b can be reduced even when the first and second radiation emitting elements 10a and 10b are under the high temperature environment, the radiation dose rate can be more accurately measured. Additionally, since the first light emitting part 11a is the same as the light emitting part 11, the first and second housings 12a and 12b are the same as the housing 12, and the first and second intermediate members 13a and 13b are the same as the intermediate member 13, a detailed description thereof will be omitted.

The second light emitting part 11b is a light emitting part which does not contain a rare earth element. The second light emitting part 11b is different from the first light emitting part 11a in that the rare earth element is not contained. That is, the second light emitting part 11b is formed of, for example, a light transmitting material such as transparent yttrium aluminum garnet.

Further, as illustrated in FIG. 11, the first radiation emitting element 10a and the second radiation emitting element 10b are provided to be adjacent to each other. Additionally, a state where the first radiation emitting element 10a and the second radiation emitting element 10b are adjacent to each other is not particularly limited as long as the first and second radiation emitting elements 10a and 10b have the same radiation dose rate.

The differential analyzer 51 is a device which is connected to the first and second electric pulse detectors 40a and 40b, calculates a difference in electric pulse count rate from the electric pulses counted by the first and second electric pulse detectors 40a and 40b, and converts the difference into the radiation dose rate. Specifically, the differential analyzer 51 includes, for example, a storage device which is described in the section of the “first Embodiment”, a calculation device which calculates a difference in electric pulse count rate obtained by the first and second electric pulse detectors 40a and 40b and converts the difference into the radiation dose rate by using a database, and a display device which displays the converted radiation dose rate (not illustrated). The differential analyzer 51 is not particularly limited as long as the electric pulse counted by the first and second electric pulse detectors 40a and 40b can be converted into the radiation dose rate as described above. For example, a personal computer having the above-described function can be adopted.

Additionally, similarly to the radiation emitting element 10 illustrated in FIG. 3, the first radiation emitting element 10a is preferably received in a virtual area in which an outer shape of the first optical fiber 20a at a connection portion between the first radiation emitting element 10a and the first optical fiber 20a is extended in the axial direction of the first optical fiber 20a and the second radiation emitting element 10b is preferably received in a virtual area in which an outer shape of the second optical fiber 20b at a connection portion between the second radiation emitting element 10b and the second optical fiber 20b is extended in the axial direction of the second optical fiber 20b. Accordingly, since it is possible to prevent a case in which the radiation measurement place is restricted by the sizes of the first and second radiation emitting elements 10a and 10b, for example, the radiation monitor can be used to measure the details and to measure a high dose rate and a high spatial resolution in combination with a medical radiotherapy apparatus.

Next, the operation of the radiation monitor 400 will be described. When the radiation dose rate is measured by using the radiation monitor 400, the first radiation emitting element 10a and the second radiation emitting element 10b are provided to be adjacent to each other. Therefore, environments involving with an incident radiation dose rate, a temperature, and an electric noise are the same in the first and second radiation emitting elements 10a and 10b.

When radiation is incident to the first radiation emitting element 10a, a photon (light) is generated at the energy transition of the rare earth element in the first light emitting part 11a. Next, the photon (light) passes through the first light attenuation filter 23a and the first wavelength filter 25a provided in the middle of the optical fiber 20a and is converted into an electric pulse in the first electric pulse converter 30a. Then, the electric pulse is counted by the first electric pulse detector 40a. At that time, there is concern that the frequency of the electric pulse per unit time with respect to the wavelength may include a frequency of a background electric pulse (hereinafter, also referred to as a “background frequency”) not caused by the radiation such as a photon generated by a heat radiation or an electric noise generated in the electric pulse converter 30 as indicated by the solid line (the apparent frequency) of FIG. 12.

Meanwhile, when the radiation is incident to the second radiation emitting element 10b, the electric pulse is counted by the second electric pulse detector 40b as described above. However, since the second light emitting part 11b does not include the rare earth element, the second electric pulse converter 30b does not emit the electric pulse caused by the rare earth element and the frequency of the electric pulse per unit time with respect to the wavelength is only the background frequency as indicated by the dashed line of FIG. 12.

Here, the electric pulse count rate obtained by the second radiation emitting element 10b is deducted from the electric pulse count rate obtained by the first radiation emitting element 10a and the difference is set as the corrected electric pulse count rate (corresponding to the integral value of the frequency of the electric pulse per unit time with respect to the wavelength indicated by the hatching of FIG. 12). Next, when the corrected electric pulse count rate is combined with a database and is converted into the radiation dose rate, the incident radiation dose rate is obtained.

In this way, since the differential analyzer 51 is provided and the first radiation emitting element 10a with the rare earth element and the second radiation emitting element 10b without the rare earth element are provided to be adjacent to each other, the radiation dose rate can be more accurately measured by removing, for example, a background such as a light emission caused by a heat radiation or an electric noise.

Further, since the radiation monitor 400 includes the first and second wavelength filters 25a and 25b, the radiation dose rate can be measured by using only the light of a predetermined wavelength range and thus the radiation dose rate can be more accurately measured even when the optical fiber is deteriorated or is under the high temperature environment.

Further, since the radiation monitor 400 includes the first and second light attenuation filters 23a and 23b, the radiation dose rate can be more accurately measured even when radiation of a high dose rate exceeding the time resolution of the electric pulse converter 30 is incident.

It should be noted that the radiation monitor of the invention is not limited to the configuration of the above-described embodiments, but includes meanings equivalent to the claims and all changes within the scope as indicated by the scope of the claims.

For example, in the first to third embodiments, a case has been described in which the light emitting part 11 contains at least one rare earth element, but does not need to essentially contain the rare earth element as long as the light emitting part can emit light of an intensity corresponding to the dose rate of the incident radiation.

Further, in the first to third embodiments, the radiation monitor in which the electric pulse detector 40 and the analyzer 50 are separated from each other has been described, but a single measurement device having a function of counting an electric pulse and a function of converting an electric pulse count rate into a radiation dose rate is also within the intended scope of the invention.

Further, in the fourth embodiment, the radiation monitor 400 including the first and second light attenuation filters 23a and 23b has been described, but a radiation monitor not including these components may be used.

Further, in the fourth embodiment, the radiation monitor 400 including the first and second wavelength filters 25a and 25b has been described, but a radiation monitor not including these components may be used.

Further, in the fourth embodiment, the radiation monitor 400 in which the first light emitting part 11a and the second light emitting part 11b are received in different housings 12a and 12b has been described, but a radiation monitor in which the first and second light emitting parts 11a and 11b are received in a single housing and the first and second light emitting parts 11a and 11b are divided by a light shielding member may be used.

Further, in the fourth embodiment, the radiation monitor 400 including the first and second intermediate members 13a and 13b and the first and second housings 12a and 12b has been described, but a radiation monitor not including the first and second intermediate members 13a and 13b or a radiation monitor not including the first and second intermediate members 13a and 13b and the first and second housings 12a and 12b may be used.

### REFERENCE SIGNS LIST

100, 200, 300, 400 radiation monitor
radiation emitting element
10a first radiation emitting element
10b second radiation emitting element
11 light emitting part
11a first light emitting part
11a second light emitting part
12 housing
12a first housing
12b second housing
13 intermediate member
13a first intermediate member
13b second intermediate member
20 optical fiber
20a first optical fiber
20b second optical fiber
23 light attenuation filter
23a first light attenuation filter
23b second light attenuation filter
25 wavelength filter
25a first wavelength filter
25b second wavelength filter
30 electric pulse converter
30a first electric pulse converter
30b second electric pulse converter
40 electric pulse detector 40a first electric pulse detector
40 second electric pulse detector
50 analyzer
51 differential analyzer
r radiation
R virtual area

1. A radiation monitor comprising:
a radiation emitting element which includes a light emitting part emitting light of an intensity corresponding to a dose rate of incident radiation;
an optical fiber which is connected to the radiation emitting element and transmits the light emitted from the light emitting part;
an electric pulse converter which is connected to the optical fiber and transmits one electric pulse for one photon of the transmitted light;
an electric pulse detector which is connected to the electric pulse converter and counts the electric pulse transmitted from the electric pulse converter; and
an analyzer which is connected to the electric pulse detector and converts the electric pulse count rate obtained by the electric pulse detector into a radiation dose rate.

2. The radiation monitor according to claim 1, further comprising:
a wavelength filter which is provided in the middle of the optical fiber and allows a transmission of only light within a predetermined wavelength range.

3. The radiation monitor according to claim 1, further comprising:
a light attenuation filter which is provided in the middle of the optical fiber and attenuates the light emitted from the radiation emitting element at a predetermined ratio so as to fall within a predetermined intensity range.

4. The radiation monitor according to claim 1,
wherein the radiation emitting element includes a light emitting part, a housing which receives the light emitting part, and an intermediate member that is provided between the housing and the light emitting part and has a thermal emissivity smaller than a thermal emissivity of an inner surface of the housing.

5. The radiation monitor according to claim 1,
wherein the light emitting part contains at least one rare earth element.

6. The radiation monitor according to claim 1,
wherein the radiation emitting element is received in a virtual area in which an outer shape of the optical fiber at a connection portion between the radiation emitting element and the optical fiber is extended in an axial direction of the optical fiber.

7. A radiation monitor comprising:
a first radiation emitting element which includes a first light emitting part containing at least one rare earth element and emitting light of an intensity corresponding to a dose rate of incident radiation;
a first optical fiber which is connected to the first radiation emitting element and transmits the light emitted from the first light emitting part;
a first electric pulse converter which is connected to the first optical fiber and transmits one electric pulse for one photon of the transmitted light;
a first electric pulse detector which is connected to the first electric pulse converter and counts the electric pulse transmitted from the first electric pulse converter;
a second radiation emitting element which includes a second light emitting part not containing a rare earth element;
a second optical fiber which is connected to the second radiation emitting element and transmits light emitted from the second light emitting part;
a second electric pulse converter which is connected to the second optical fiber and transmits one electric pulse for one photon of the transmitted light;
a second electric pulse detector which is connected to the second electric pulse converter and counts the electric pulse transmitted from the second electric pulse converter; and
a differential analyzer which is connected to the first and second electric pulse detectors, calculates a difference in electric pulse count rate from the electric pulses counted by the first and second electric pulse detectors, and converts the difference into a radiation dose rate,
wherein the first radiation emitting element and the second radiation emitting element are provided to be adjacent to each other.

8. The radiation monitor according to claim 7, further comprising:
a first wavelength filter which is provided in the middle of the first optical fiber and allows a transmission of only light within a predetermined wavelength range; and
a second wavelength filter which is provided in the middle of the second optical fiber and allows a transmission of only light within the predetermined wavelength range.

9. The radiation monitor according to claim 7, further comprising:
a first light attenuation filter which is provided in the middle of the first optical fiber and attenuates the light emitted from the first radiation emitting element at a predetermined ratio as to fall within a predetermined intensity range; and
a second light attenuation filter which is provided in the middle of the second optical fiber and attenuates the light emitted from the second radiation emitting element at the predetermined ratio so as to fall within the predetermined intensity range.

10. The radiation monitor according to any one of claim 7,
wherein the first radiation emitting element includes a first light emitting part, a first housing which receives the first light emitting part, and a first intermediate member that is provided between the first housing and the first light emitting part and has a thermal emissivity smaller than a thermal emissivity of an inner surface of the first housing, and
wherein the second radiation emitting element includes a second light emitting part, a second housing which receives the second light emitting part, and a second intermediate member that is provided between the second housing and the second light emitting part and has a thermal emissivity smaller than a thermal emissivity of an inner surface of the second housing.

11. The radiation monitor according to claim 7,
wherein the first radiation emitting element is received in a virtual area in which an outer shape of the first optical fiber at a connection portion between the first radiation emitting element and the first optical fiber is extended in an axial direction of the first optical fiber, and
wherein the second radiation emitting element is received in a virtual area in which an outer shape of the second optical fiber at a connection portion between the second radiation emitting element and the second optical fiber is extended in an axial direction of the second optical fiber.

12. A radiation monitoring method comprising:
emitting light of an intensity corresponding to a dose rate of incident radiation from a light emitting part of a radiation emitting element;
transmitting the light emitted from the light emitting part by an optical fiber;
transmitting one electric pulse for one photon of the transmitted light by an electric pulse converter;
counting the electric pulse transmitted from the electric pulse converter by an electric pulse detector; and
converting the electric pulse count rate counted by the electric pulse detector into a radiation dose rate by an analyzer.
